(19) United States
(12) Patent Application Publication
(10) Pub. No.: US 2022/0402742 A1
(43) Pub. Date: Dec. 22, 2022

(54) BEVERAGE DISPENSER WITH REMOVABLE WATER CONTAINER AND CARBONATOR ASSEMBLY

(71) Applicants: Clyde PITTAWAY, Durham (GB); Durham ELLIOTT, Durham (GB)

(72) Inventors: Clyde PITTAWAY, Durham (GB); Durham ELLIOTT, Durham (GB)

(21) Appl. No.: 17/764,621

(22) PCT Filed: Oct. 16, 2020
(86) PCT No.: PCT/GB2020/052610

§ 371 Date: Mar. 29, 2022

(30) Foreign Application Priority Data
Oct. 16, 2019 (GB) 1914969.9

(51) Int. Cl. B67D 1/00; B67D 1/07; B67D 1/10; B67D 1/12; B01F 23/236

(52) U.S. Cl. CPC B67D 1/006; B67D 1/0014; B67D 1/0009; B67D 1/0016; B67D 1/07; B67D 1/10; B67D 1/125; B01F 23/2362; B67D 2001/0097; B67D 2210/00034; B67D 2001/0093; B01F 2101/14

(57) ABSTRACT

The apparatus includes a reservoir (2), a liquid source (1), a carbon dioxide source (12), a non-return valve (8), a carbonating vessel (7) to receive liquid from the reservoir (2) via the non-return valve (8), a gas inlet (15) to receive carbon dioxide from the carbon dioxide source (12), and a dip tube (16) to withdraw carbonated liquid from the carbonating vessel. A pressure relief valve (20) vents gas from the carbonating vessel (7), and a dispense valve (18) controls the supply of carbonated liquid from the dip tube (16) to a dispense outlet (17). A charge control valve (14) controls the supply of carbon dioxide to the carbonating vessel (7). The apparatus has the following modes of operation-charge: the dispense valve (18) is held closed while the charge control valve (14) is opened to admit a charge of carbon dioxide into the carbonating vessel (7); dispense/refill: the dispense valve (18) is opened to dispense carbonated liquid while liquid flows into the carbonating vessel from the reservoir (2) via the non-return valve (8). The carbonated beverage can

NZ, OM, PA, PE, PG, PH, PL, PT, QA, RO, RS, RU, RW, SA, SC, SD, SE, SG, SK, SL, ST, SV, SY, TH, TJ, TM, TN, TR, TT, TZ, UA, UG, US, UZ, VC, VN, WS, ZA, ZM, ZW.

### TECHNICAL FIELD OF THE INVENTION

This invention relates to apparatus for producing carbonated beverages, more particularly water coolers.

### BACKGROUND

Ebac Limited has, for many years, manufactured water coolers which incorporate a WaterTrail system (Registered Trade Mark). The concept of this system is that all of the components in the liquid flow path from the water inlet to the dispense outlet can be replaced during periodic maintenance to minimise the risk of potentially pathogenic bacteria being present in the drinking water. Such a water cooler is disclosed in European Patent No. 0 581 492-B and others.

Known water coolers may include a CO₂ system that allows cooled carbonated water (soda water) to be dispensed on demand. In a typical system a carbonating vessel is permanently connected to a source of high-pressure CO₂ gas. A positive displacement diaphragm pump operating at about 7 Bar (100 psi) forces cooled water into the carbonating vessel to mix with the CO₂ and dispense the carbonated water when required. A non-return valve between the pump and the carbonating vessel ensures that the pressure is restricted to the CO₂ side. If the gas pressure in the vessel becomes too high, typically more than about 8 bar (115 psi), a pressure reducing valve (PRV) vents excess gas. This system is very convenient because it can dispense continuously to produce large volumes of carbonated water on demand. A water cooler of this general kind which is used for dispensing oxygenated water is disclosed in WO 02/051739 A2.

In a WaterTrail system, all of the components which come into contact with the water need to be replaceable. This presents a challenge with a carbonating system as described above because although the integrated positive displacement pump has the major benefit of instant dispense it has drawbacks with regard to the WaterTrail system. Water flows through the head of the dispense pump so this part of the pump would need to be replaceable. This represents a technical challenge as the pump head incorporates components which are manufactured to fine tolerances, and the pump encounters relatively high pressures. The cost of such a WaterTrail will therefore be high due to the extra parts and complexity. Installation of a replacement WaterTrail would also be much more complicated.

Many carbonating water coolers use a variant of the system described above, but since the cost of replacing the pump head is prohibitive most require periodically flushing with cleaning solution to maintain an acceptable level of hygiene.

The present invention seeks to provide a new and inventive form of carbonated beverage dispenser which is capable of producing sufficient quantities of carbonated beverage without an unacceptable delay, and which is capable of maintaining good hygiene at low cost and minimum inconvenience.

### SUMMARY OF THE INVENTION

When viewed from one aspect the present invention proposes apparatus for producing carbonated beverages according to claim 1 hereof.

In an embodiment the controller (35) has the following modes of operation
charge: the dispense valve (18) is held closed while the charge control valve (14) is opened to admit a charge of carbon dioxide into the carbonating vessel (7);
dispense/refill: the dispense valve (18) is opened to dispense carbonated liquid while liquid flows into the carbonating vessel from the reservoir (2) via the non-return valve (8).

In an embodiment the charge control valve (14) is closed for at least part of the dispense/refill period.

The invention also provides a flow assembly (30) for use in apparatus for producing carbonated beverages according to claim 15 hereof.

The invention further provides a method of operating apparatus for producing carbonated beverages according to claim 16 hereof.

In another aspect the invention provides apparatus for producing carbonated beverages in which a quantity of non-carbonated liquid is dispensed to dilute the strength of the dispensed carbonated liquid.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic diagram of a gravity-fed dispensing apparatus for producing carbonated beverages;

FIG. 2 is a schematic diagram of a bottom loader type dispensing apparatus for producing carbonated beverages;

FIG. 3 is a schematic view of a centrifugal pump as used in the dispensing apparatus of FIG. 2;

FIG. 4 is a schematic diagram of a modified bottom loader dispensing apparatus for producing carbonated beverages;

FIG. 5 is a general view of a diverter valve as used in the dispensing apparatus of FIG. 4.

### DETAILED DESCRIPTION OF THE DRAWINGS

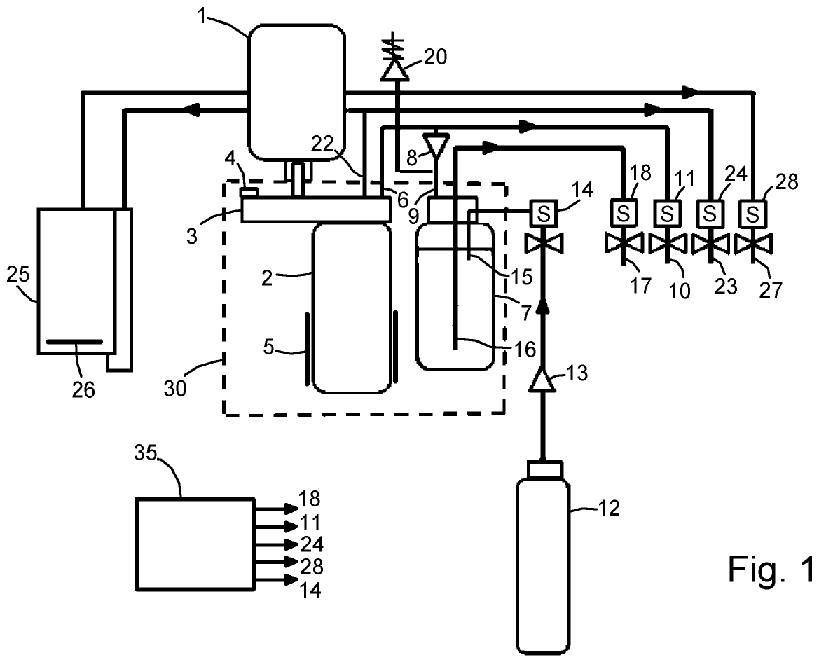

Referring firstly to FIG. 1, a liquid source 1 in the form of an inverted bottle of water is arranged to supply water to a reservoir 2 via a manifold 3. Water flows to the reservoir 2 under gravity, being replaced by air which enters the manifold through an air filter 4. Inside the reservoir 2, water is chilled by a cooling element 5, which may for example be the evaporator of a vapour compression refrigeration system, a thermoelectric cooling element, etc. Chilled water leaving the reservoir 2 through a first manifold outlet 6 enters a carbonating vessel 7 via a first non-return valve 8 and a liquid inlet 9. Chilled water from the first manifold outlet 6 may also be dispensed directly via a chilled water dispense outlet 10 controlled by a solenoid-operated valve 11.

A carbon dioxide source provided by a gas cylinder 12 supplies carbon dioxide under pressure (typically greater than 7 bar) via a second non-return valve 13 and a charge control valve 14, entering the carbonating vessel 7 via a gas inlet 15 below the normal water level. Carbonated liquid can be withdrawn from the carbonating vessel 7 through a dip tube 16 to supply a carbonated liquid dispense outlet 17 controlled by a solenoid-operated valve 18. A pressure-release valve (PRV) 20 is provided to vent the carbonating vessel 7 to atmosphere, which may conveniently be connected to the carbonating vessel via the liquid inlet 9 downstream of the non-return valve 8. PRV 20 may be set to open progressively over a typical range of about 0.5 bar to about 5 bar. Below 0.5 bar the PRV is completely shut, thereby maintaining a small residual positive pressure within the carbonating vessel. When the pressure reaches 5 bar the PRV is fully open, ensuring that the internal pressure cannot exceed the design pressure of the system.

The manifold 3 has a second manifold outlet 22 through which ambient water can flow from the bottle 1 without passing through the reservoir 2. This outlet supplies an ambient water dispense outlet 23 controlled by a solenoid-operated valve 24 to supply ambient water when required. The second outlet 22 may also supply a hot tank 25 provided with a resistance heating element 26, from which hot water may be supplied to a hot water dispense outlet 27 controlled by a solenoid-operated valve 28 to supply hot water when required.

A flow assembly 30 defines the liquid flow path between the bottled liquid source 1 and the carbonated liquid dispense outlet 17, including the manifold 3, reservoir 2, and the carbonating vessel 7. Also included within the flow assembly are all of the other components within the cold water and ambient water flow paths such as the first non-return valve 8 and the conduits leading to the carbonated water, chilled water and ambient water dispense outlets 17, 10 and 23. The solenoid-operated dispense valves 18, 11 and 24 are typically pinch valves which operate on respective sections of flexible conduit that are withdrawn from the dispense valves during replacement of the flow assembly. The conduit supplying the hot tank 25 is also included in the flow assembly, but not the hot tank itself or the conduit between the hot tank and the hot water dispense outlet 27 as these are self-sanitized by the hot water. During a periodic maintenance operation, the flow assembly 30 can be removed from the apparatus and replaced with a clean flow assembly.

A controller 35 is arranged to control operation of the dispensing apparatus, including the solenoid-operated dispense valves 18, 11, 24 and 28 and the charge control valve 14. When dispensing chilled, ambient or hot water the controller 35 operates to open the relevant dispensing valves in known manner. In respect of the carbonation system, the controller produces different stages of operation, as follows:
Charge: The carbonated water dispense valve 18 is held closed while the gas charge control valve 14 is opened for sufficient time to admit a charge of carbon dioxide into the carbonating vessel 7. PRV 20 opens to maintain a maximum internal pressure of 5 bar, allowing excess pressure to vent safely. When the charge has been admitted the valve 14 is closed allowing the internal pressure to stabilise with a positive pressure ready for dispense.
Dispense/Refill: The charge control valve 14 is closed and the dispense valve 18 is opened to dispense carbonated liquid. The internal pressure will be higher at the beginning of dispense but the PRV 20 ensures a minimum pressure of 0.5 bar is maintained. When the internal pressure in vessel 7 falls below the liquid pressure within the reservoir 2 the carbonating vessel re-fills via the first non-return valve 8.

During charging the internal gas pressure may rise as high as 5 bar to aid carbonation. The PRV 20 vents air and excess CO₂ to atmosphere allowing continued exposure and mixing with CO₂ throughout the charging process. By way of example, it has been found that with a 600 ml carbonation vessel, carbonation is most effective with a charge time of just 2.0-2.5 seconds. Beyond that time the full charge pressure has already been reached and gas is just lost to atmosphere.

Since the carbonation vessel remains closed with a small positive pressure after charging the liquid remains carbonated for a considerable time. After charging, the pressure typically rises to around 1.5 bar as a result of CO₂ leaving the liquid until a state of equilibrium is reached. From then on the carbonation level remains constant and does not fall significantly even after 30 hours.

Since the PRV 20 always maintains a positive pressure of at least 0.5 bar (relative to atmospheric pressure) dispensing of carbonated liquid commences immediately and is thereafter sustained by flow of liquid from the reservoir 2. This ensures that dispensing of carbonated liquid takes place at an optimum rate.

When the controller 35 receives a user-initiated dispense command (e.g. by pressing a ‘dispense’ button) two operating sequences are possible. In a preferred arrangement the controller operates with the sequence: dispense/refill—charge. This sequence has the advantage that there is minimum delay between initiating a dispense command and dispensing the carbonated water. The carbonating vessel 7 always holds a charge of carbonated liquid which is ready to dispense. If the customer requires a diluted drink the chilled water dispense valve 11 may be opened to dilute the dispensed carbonated water to the required level.

In an alternative operating sequence following a user-initiated dispense demand the controller may operate with the sequence:
charge—dispense/refill. This introduces a longer delay before the liquid is dispensed, but in this case the carbonation strength can be set to the strength selected by the user without dilution. To achieve this the amount of CO₂ introduced to the carbonating vessel may be varied, e.g. by changing the opening time of the charge control valve 14, depending on the amount of liquid added during the previous refill and the selected carbonation strength.

In an example of the dispense/refill-charge sequence in the gravity feed system of FIG. 1, when the user selects a carbonated drink, the CO₂ dispense solenoid 18 opens and the carbonated water is dispensed. After dispensing the required amount, the solenoid closes. The controller 35 can register the timings and carbonation levels of the previous two drinks dispensed, from which the charge time required to carbonate the next refill can be calculated. When the charge solenoid 14 opens to allow the required amount of CO₂ into the carbonating vessel 7 the dispense solenoid 18 is locked closed and an illuminated symbol may inform users that the charging process is taking place. The PRV 20 opens to vent air and excess CO₂ from the carbonation vessel. Another indicator may signal when charging is complete and the carbonated drink is ready to dispense.

In an example of the charge-dispense/refill sequence, the user selects the required carbonating strength and the charge solenoid opens to allow the required amount of CO₂ into the carbonating vessel 7. During this operation the CO₂ dispense solenoid 18 is locked closed and an illuminated symbol may inform the user that the charging process is taking place. The PRV 20 opens to vent air and excess CO₂ from the reservoir. Another indicator highlights when the carbonated drink is ready to dispense. On receipt of a dispense command, the dispense solenoid opens and the carbonated water is dispensed. After dispensing the required amount, the solenoid 18 closes. The controller can register the timings and carbonation levels of the previous two drinks dispensed which are used to determine the charge time required to carbonate the next refill.

The gravity fed system has many benefits as compared with systems that require a high pressure positive displacement pump. Air leaks and pressure drops are less likely and flow rates are improved, with no delays due to pressure loss. The gravity-fed system is self-priming after a bottle change, and the flow assembly is greatly simplified without a pump. The risk of an over-pressure condition is also much reduced.

In another embodiment the liquid source 1 could be taken from a piped water main rather than a bottle. Like the gravity feed system, no water pump is required as the dispensing pressure is supplied by the pressure of the water main.

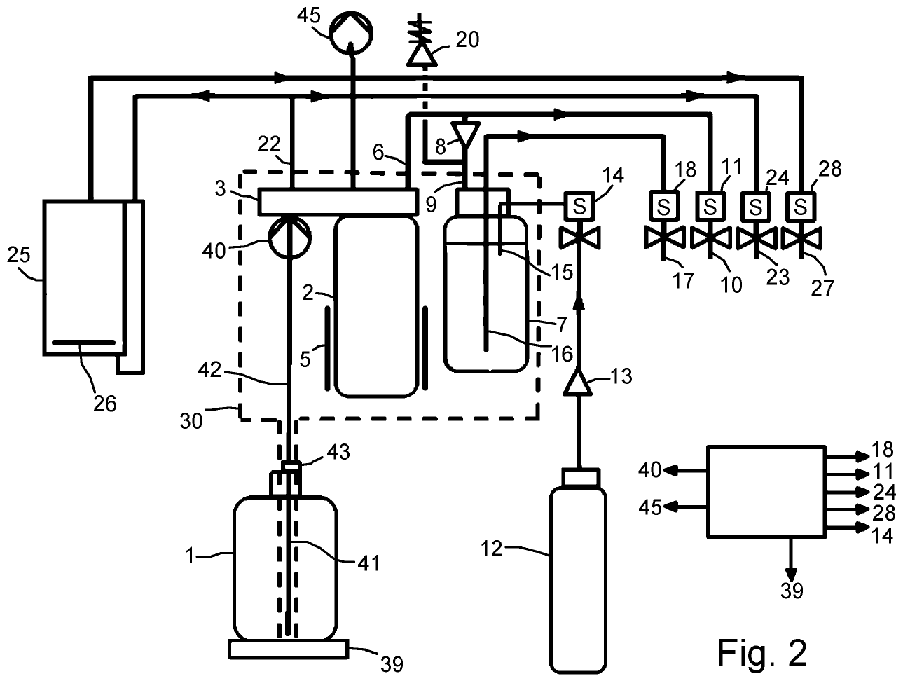

FIG. 2 shows a further embodiment of the dispensing apparatus in which the bottle is mounted at a lower level than the reservoir—a so-called bottom loader. Components which are common to FIG. and perform similar functions have the same reference numerals. In this embodiment the liquid source 1 is a bottle arranged to supply water to a reservoir 2 via a manifold 3. A load cell 39 monitors the weight of the bottle to provide an accurate indication of the amount of water in the bottle. A brushless dispense pump 40 associated with the manifold 3 draws water from the bottle 1 through a draw tube 41 and conduit 42, being replaced by air which enters the bottle through an air filter 43. Inside the reservoir 2, water is chilled by a cooling element 5, e.g. the evaporator of a vapour compression refrigeration system, a thermoelectric cooling element, etc. Chilled water leaving the reservoir 2 through a first manifold outlet 6 enters a carbonating vessel 7 via a first non-return valve 8 and a liquid inlet 9. Chilled water from the first manifold outlet 6 may also be dispensed directly via a chilled water dispense outlet 10 controlled by a solenoid-operated valve 11.

A carbon dioxide source provided by a gas cylinder 12 supplies carbon dioxide under pressure (typically greater than 7 bar) via a second non-return valve 13 and a charge control valve 14, entering the carbonating vessel 7 via a gas inlet 15 below the normal water level. Carbonated liquid can be withdrawn from the carbonating vessel 7 through a dip tube 16 to supply a carbonated liquid dispense outlet 17 controlled by a solenoid-operated valve 18. A pressure-release valve (PRV) 20 is provided to vent the carbonating vessel 7 to atmosphere, which may conveniently be connected to the carbonating vessel via the liquid inlet 9 downstream of the non-return valve 8. PRV 20 may be set to open progressively over a typical range of about 0.5 bar to about 5 bar. Below 0.5 bar the PRV is completely shut, thereby maintaining a small residual positive pressure within the carbonating vessel. When the pressure reaches 5 bar the PRV is fully open, ensuring that the internal pressure cannot exceed the design pressure of the system.

The manifold 3 has a second manifold outlet 22 through which ambient water can flow from the bottle 1 without passing through the reservoir 2. This outlet supplies an ambient water dispense outlet 23 controlled by a solenoid-operated valve 24 to supply ambient water when required. The second outlet 22 may also supply a hot tank 25 provided with a resistance heating element 26, from which hot water may be supplied to a hot water dispense outlet 27 controlled by a solenoid-operated valve 28 to supply hot water when required.

In this embodiment the manifold 3 is also provided with a suction pump 45 which is used for priming the system as described below.

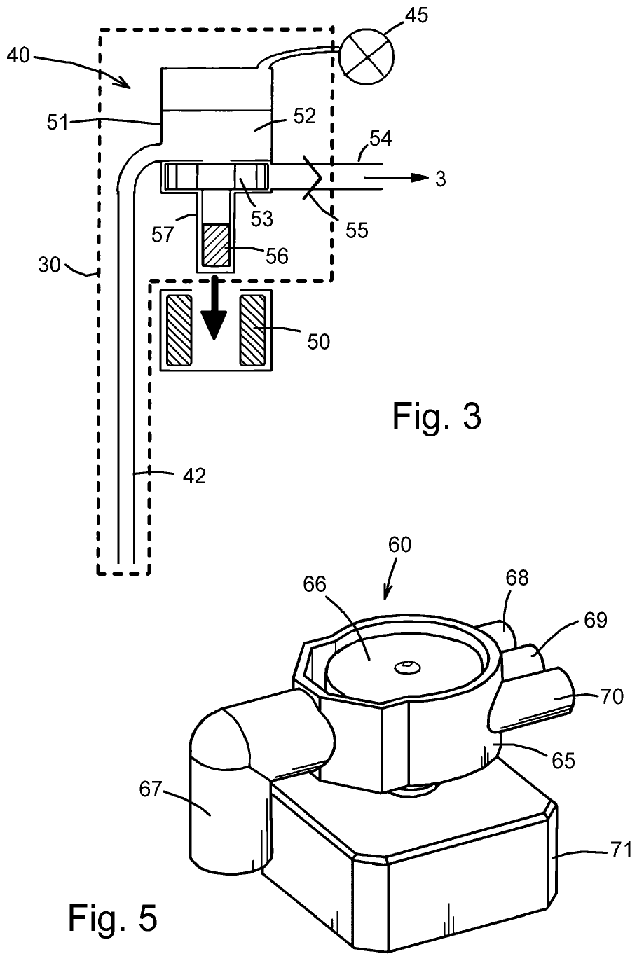

Referring to FIG. 3, the dispense pump 40 is in two parts, namely a driving coil 50 which is fixed with the dispensing apparatus and a low cost disposable pump head 51 which is fixed with the manifold 3. The pump head includes a chamber 52, which may be part of the manifold 3, which is fed with water from the bottle conduit 42. The top of this chamber is connected to the suction pump 45. The bottom part of the chamber contains a centrifugal impeller 53 which supplies water to the manifold via an outlet 54 which preferably includes a check valve 55. The impeller 53 is rotated by a magnet 56 which is located in a well 57 removably received within the driving coil 50. Although the pump head 51 is part of the replaceable flow assembly 30, the magnet 56 is releasably connected the pump head so that the magnet can be recovered for re-use and the plastic components recycled. It is important to note that the centrifugal impeller pump operates at a much lower pressure differential than the positive displacement diaphragm pumps which are generally used in carbonated water dispensers. This kind of dispense pump cannot over-pressurise the system. If the pressure upstream of the pump increases then less water comes through the pump.

Referring once again to FIG. 2, a flow assembly 30 defines the liquid flow path between the bottled liquid source 1 and the carbonated liquid dispense outlet 17. The flow assembly 30 includes the draw tube 41, the pump head 51 (FIG. 3), the manifold 3, reservoir 2, and the carbonating vessel 7. Also included within the flow assembly are all of the other components within the cold water and ambient water flow paths such as the first non-return valve 8 and the interconnecting conduits such as the conduit 42 and the conduits leading to the carbonated water, chilled water and ambient water dispense outlets 17, 10 and 23. The solenoid-operated dispense valves 18, 11 and 24 are typically pinch valves which operate on respective sections of flexible conduit that are withdrawn from the dispense valves during replacement of the flow assembly. The conduit supplying the hot tank 25 is also included in the flow assembly, but not the hot tank itself or the conduit between the hot tank and the hot water dispense outlet 27 as these are self-sanitized by the hot water. During a periodic maintenance operation, the flow assembly 30 can be removed from the apparatus and replaced with a clean flow assembly.

A controller 35 is arranged to control operation of the dispensing apparatus, including the solenoid-operated dispense valves 18, 11, 24 and 28 and the charge control valve 14. The controller 35 also controls the driving coil of the dispense pump 40 and the suction pump 45. The suction pump 45 displaces air from the manifold to prime the dispense pump 40. During dispense the power drawn by the pump 40 is monitored by the controller. When the water runs out and the pump runs dry there is a drop in power which the controller detects and stops the pump. On changing the bottle the load cell pressure sensor 39 enables the controller to detect when the new bottle is in place and trigger the suction pump 45 to re-prime the system. When water enters the dispense pump chamber 52 the power drawn by the dispense pump increases, which is detected by the controller and the priming pump 45 is stopped.

When dispensing chilled, ambient or hot water the controller 35 operates to open the relevant dispensing valves in a similar manner to the gravity feed system. When dispensing carbonated beverages the controller again operates in charge and dispense/refill modes in either of the sequences described above. When the CO₂ dispense solenoid valve 18 opens the centrifugal dispense pump 40 runs to feed chilled water into the carbonation vessel 7 and dispense the carbonated water. After dispensing the required amount, the dispense valve closes and the dispense pump stops running.

The low pressure centrifugal dispensing pump system also has benefits as compared with systems that require a high pressure positive displacement pump. Air leaks and pressure drops are less likely and flow rates are improved, with no delays due to pressure loss. Priming the system after a bottle change is very rapid and the flow assembly is greatly simplified. The risk of an over-pressure condition is also reduced.

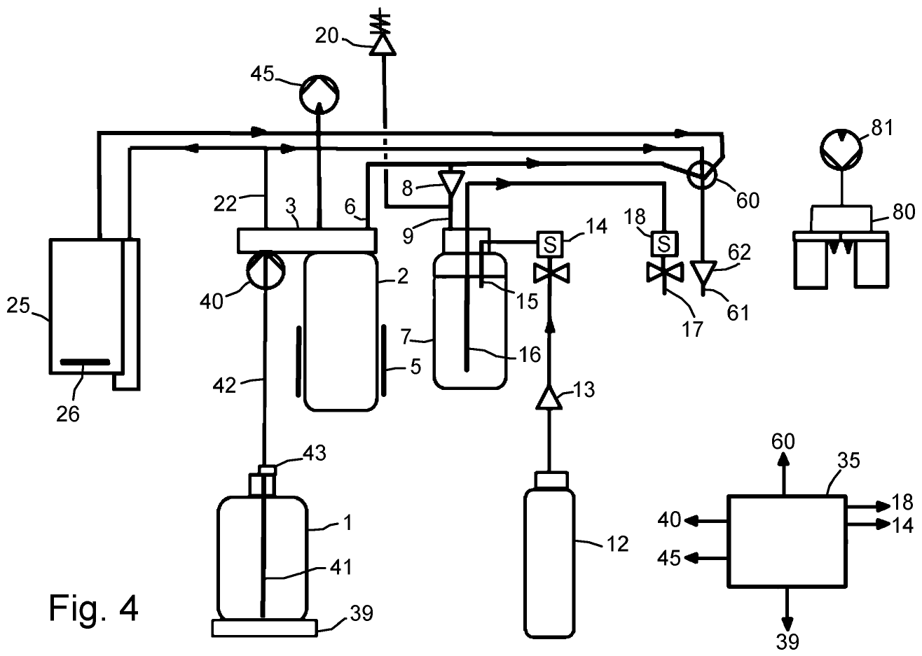

FIG. 4 shows a preferred embodiment of a bottom loader dispensing apparatus which operates with the dispense/refill −charge sequence. The user can select the carbonation strength, with minimum delay between initiating a dispense command and dispensing the carbonated water. Components which are common to FIGS. 1 and 2 and perform similar functions have the same reference numerals. In this embodiment the liquid source 1 is a bottle arranged to supply water to a cold reservoir 2 (typically about 1.6 litres) via a manifold 3. A load cell 39 monitors the weight of the bottle to provide an accurate indication of the amount of water in the bottle. A brushless dispense pump 40 which is associated with the manifold 3 draws water from the bottle 1 through a draw tube 41 and conduit 42, being replaced by air which enters the bottle through an air filter 43. The dispense pump 40 may be the two-part centrifugal pump as described above in relation to FIG. 3. Inside the reservoir 2, water is chilled by a cooling element 5, e.g. the evaporator of a vapour compression refrigeration system, a thermoelectric cooling element, etc. Chilled water leaving the reservoir 2 through a first manifold outlet 6 enters a carbonating vessel 7 via a first non-return valve 8 and a liquid inlet 9. Chilled water from the first manifold outlet 6 may also be dispensed via a diverter valve 60 to a still water dispense outlet 61 provided with a check valve 62 to prevent reverse flow into the system.

A carbon dioxide source provided by a gas cylinder 12 supplies carbon dioxide under pressure (typically greater than 7 bar) via a second non-return valve 13 and a charge control valve 14, entering the carbonating vessel 7 via a gas inlet 15 below the normal water level. Carbonated liquid can be withdrawn from the carbonating vessel 7 through a dip tube 16 to supply a carbonated liquid dispense outlet 17 controlled by a solenoid-operated valve 18. A pressure-release valve (PRV) 20 is provided to vent the carbonating vessel 7 to atmosphere, which may conveniently be connected to the carbonating vessel via the liquid inlet 9 downstream of the non-return valve 8. PRV 20 may be set to open progressively over a typical range of about 0.5 bar to about 5 bar. Below 0.5 bar the PRV is completely shut, thereby maintaining a small residual positive pressure within the carbonating vessel. When the pressure reaches 5 bar the PRV is fully open, ensuring that the internal pressure cannot exceed the design pressure of the system.

The manifold 3 has a second manifold outlet 22 through which ambient water can flow from the bottle 1 without passing through the reservoir 2. This outlet supplies the dispense outlet 61 via another port of the diverter valve 60 to supply ambient water when required. The second outlet 22 may also supply a hot tank 25 (typically 1.5 litres) provided with a resistance heating element 26, from which hot water may be supplied to the dispense outlet 61 via a further port of the diverter valve 60 to supply hot water when required.

The manifold 3 is also provided with a suction pump 45 which is used for priming the system as described above in relation to FIGS. 2 and 3.

Referring to FIG. 5, the diverter valve 60 includes a valve housing 65 provided with an outlet port 67 and three input ports, namely a cold port 68, an ambient port 69 and a hot port 70. The housing contains a rotary valve body 66 which is configured to selectively connect the outlet port 67 to any of the three input ports 68-70. The valve housing 65 and valve body 66 are releasably engaged with a fixed stepper motor 71 which can rotate the valve body into various required positions, for example:
Hot—outlet port 67 connects with the hot port 70
Cook—outlet port connects with the ambient port 69
Cold—outlet port connects with the cold port 68
Cold 5%—valve body restricts flow from the cold port to 5%
Cold 10%—valve body restricts flow from the cold port to 10%

The valve 60 may remain in the cold position by default. If the dispense ump 40 is not running no water will be dispensed.

Since the diverter valve uses a stepper motor 71 the flow through any of the inlet ports can be precisely set anywhere between 0% (closed) and 100% (fully open).

Referring back to FIG. 4, as described in the above embodiments a flow assembly defines the liquid flow path between the bottled liquid source 1 and the carbonated liquid dispense outlet 17. The flow assembly 30 includes the draw tube 41, the pump head of the centrifugal pump 40, the manifold 3, reservoir 2, and the carbonating vessel 7. Also included within the flow assembly are all of the other components within the cold water and ambient water flow paths such as the first non-return valve 8 and the interconnecting conduits such as the conduit 42 and the conduits leading to the carbonated water dispense outlet 17 and still water outlet 61. The flow assembly also includes the diverter valve housing 65 and valve body 66 which can be released from the fixed stepper motor and replaced with the flow assembly. The solenoid-operated dispense valve 18 is typically a pinch valve which operates on a section of flexible conduit that is withdrawn from the dispense valve during replacement of the flow assembly. The conduit supplying the hot tank 25 is also included in the flow assembly, but not the hot tank itself or the conduit between the hot tank and the diverter valve 60 as these are self-sanitized by the hot water. During a periodic maintenance operation, the flow assembly 30 can be removed from the apparatus and replaced with a clean flow assembly.

A flavour enhancement dosing system is included in the dispensing apparatus. The dosing system includes a disposable container 80 which holds a concentrated flavour enhancement such as a fruit flavouring. An air pump 81 is arranged to produce a flow of air which entrains droplets of the concentrated flavour enhancement and delivers them into the dispensed liquid. A similar dosing system can be incorporated in any of the carbonated beverage dispensing systems disclosed herein.

A controller 35 is arranged to control operation of the dispensing apparatus, including the solenoid-operated dispense valve 18 and the charge control valve 14. The controller 35 also controls the driving coil of the dispense pump 40, the suction pump 45, and the stepper motor of the diverter valve 60.

When dispensing non-carbonated chilled, ambient or hot water the controller 35 operates the stepper motor to rotate the diverter valve 60 to the required position, and the centrifugal dispense pump 40 runs to pressurize the system and dispense the water from the still water outlet 61 at the required temperature. The carbonating vessel 7 always holds a charge of carbonated liquid at maximum strength which is ready to dispense. To dispense carbonated water the user first selects the desired carbonation strength. If the customer selects a strong drink only carbonated water is dispensed, but if they require a diluted drink the controller 35 rotates the diverter valve 60 to select cold water at an appropriate flow rate depending on the dilution strength selected. The user may then press and hold a dispense button until the required amount of liquid has been dispensed. The CO₂ dispense valve 18 opens and the centrifugal dispense pump 40 runs to feed chilled water into the carbonation vessel 7 and simultaneously dispense the carbonated and chilled water. After releasing the dispense button the solenoid valve 18 closes and the pump 40 shuts down. The controller 35 can register the timings and carbonation levels of the previous two drinks dispensed, from which the charge time required to carbonate the liquid to maximum strength can be calculated. The charge solenoid then opens to allow the required amount of CO₂ into the carbonation vessel. The PRV 20 vents air and excess CO₂ to atmosphere allowing continued mixing of the liquid with CO₂ throughout the charging process. During this part of the operation the CO₂ dispense solenoid is locked closed and an illuminated symbol may inform users that the charging process is taking place. Another indicator may signal when charging is complete and the carbonated drink is again ready to dispense.

The liquid in the carbonating vessel remains carbonated for a considerable time and the carbonation level does not fall significantly even after 30 hours.

In addition to cold carbonated water at various dilutions the user could also select ambient water (cook) to obtain a carbonated drink closer to room temperature. A hot carbonated drink would not normally be possible.

Following a change of the bottle 1 the suction pump 45 displaces air from the manifold 3 to prime the dispense pump 40. During dispense the power drawn by the pump 40 is monitored. When the water runs out and the pump runs dry there is a drop in power which the controller detects and stops the pump. On changing the bottle the load cell pressure sensor 39 enables the controller to detect when the new bottle is in place and trigger the suction pump 45 to re-prime the system. When water enters the dispense pump chamber 52 the power drawn by the dispense pump increases, which is detected by the controller and the priming pump 45 is stopped.

The dispensing system is capable of dispensing a carbonated beverage of the required strength with minimum delay, similar to a high pressure dispensing system, but air leaks and pressure drops are less likely and flow rates are improved, with no delays due to pressure loss. Priming the system after a bottle change is very rapid and replacement of the flow assembly is quick and straightforward. The risk of an over-pressure condition is also much reduced.

It is noted that in each of the systems described above the charge valve 14 could be opened under controlled conditions during dispense to boost the carbonation level, particularly when larger volumes are being dispensed.

In each embodiment of the dispensing apparatus the carbonation system does not require a high pressure positive displacement pump, such as a diaphragm pump, in the water flow path and does not have the same sanitization issues as carbonation systems which require a relatively high water pressure. The WaterTrail flow assembly is a simpler unit which is easier to install, more economical to manufacture, and potentially allows 100% sanitization to be obtained on replacement. Manufacturing costs are lower, and the replacement flow assembly has less environmental impact. The carbonated water dispenser also has the advantage of being significantly quieter in operation with less CO₂ gas noise.

Whilst the above description places emphasis on the areas which are believed to be new and addresses specific problems which have been identified, it is intended that the features disclosed herein may be used in any combination which is capable of providing a new and useful advance in the art.

1. Apparatus for producing carbonated beverages:
a reservoir (2);
a liquid source (1) to supply liquid;
a carbon dioxide source (12) to supply carbon dioxide;
a non-return valve (8);
a carbonating vessel (7) having a liquid inlet (9) to receive liquid from the reservoir (2) via the non-return valve (8), a gas inlet (15) to receive carbon dioxide from the carbon dioxide source (12), and a dip tube (16) to withdraw carbonated liquid from the carbonating vessel;
a dispense outlet (17) for carbonated liquid;
a dispense valve (18) to control the supply of carbonated liquid from the dip tube (16) to the dispense outlet (17);
a flow assembly (30) defining a liquid flow path between the liquid source (1) and the dispense outlet (17), said flow assembly including the reservoir (2) and the carbonating vessel (7);
a pressure relief valve (20) to vent gas from the carbonating vessel (7);
a charge control valve (14) to control the supply of carbon dioxide from the carbon dioxide source (12) to the carbonating vessel (7);
a controller (35) arranged to control the dispense valve (18) and the charge control valve (14);
wherein, during a maintenance operation, the flow assembly (30) can be removed from the apparatus and replaced.

2. Apparatus for producing carbonated beverages according to claim 1 wherein the controller (35) has the following modes of operation
charge: the dispense valve (18) is held closed while the charge control valve (14) is opened to admit a charge of carbon dioxide into the carbonating vessel (7);
dispense/refill: the dispense valve (18) is opened to dispense carbonated liquid while liquid flows into the carbonating vessel from the reservoir (2) via the non-return valve (8).

3. Apparatus for producing carbonated beverages according to claim 2 wherein the charge control valve (14) is closed for at least part of the dispense/refill period.

4. Apparatus for producing carbonated beverages according to claim 2 wherein, on receipt of a dispense command, the controller operates with the sequence: dispense/refill −charge.

5. Apparatus for producing carbonated beverages according to claim 2 wherein, on receipt of a dispense command, the controller operates with the sequence: charge −dispense/refill.

6. Apparatus for producing carbonated beverages according to claim 1 wherein the controller (35) monitors the carbonation level during a previous dispense operation and controls the opening time of the charge control valve (14) to vary the charge of carbon dioxide admitted to the carbonating vessel (7) according to the previous carbonation level.

7. Apparatus for producing carbonated beverages according to claim 1 wherein the charge of carbon dioxide is introduced into the closed carbonating vessel (7) below the water level.

8. Apparatus for producing carbonated beverages according to claim 1 wherein the liquid source (1) is arranged such that liquid flows into the reservoir (7) by gravity.

9. Apparatus for producing carbonated beverages according to claim 1 wherein the liquid source (1) is a water main which is arranged to fill the reservoir (7) by mains pressure.

10. Apparatus for producing carbonated beverages according to claim 1 wherein the liquid source (1) is arranged to supply liquid to the reservoir (7) via a two-part dispense pump (40) having a driving element (50) which is fixed with the dispensing apparatus and a pump head (51) which is part of the flow assembly (30).

11. Apparatus for producing carbonated beverages according to claim 10 wherein the pump head (51) is a centrifugal pump head.

12. Apparatus for producing carbonated beverages according to claim 1 which includes a diverter valve (60) arranged to supply ambient water from the liquid source (1) and chilled water from the reservoir (2) to a common dispense outlet (61).

13. Apparatus for producing carbonated beverages according to claim 12 wherein the diverter valve (60) is operated by the controller (35).

14. Apparatus for producing carbonated beverages according to claim 1 having a flavour enhancement dosing system which includes:
a disposable container (80) which holds a concentrated flavour enhancement;
an air pump (81);
wherein the air pump (81) is arranged to produce a flow of air which entrains droplets of the concentrated flavour enhancement and delivers them into the dispensed liquid.

15. A flow assembly (30) for use in apparatus for producing carbonated beverages which apparatus includes a liquid source (1), a carbon dioxide source (12), a dispense valve (18), a charge control valve (14), and a controller (35) arranged to control the dispense valve (18) and the charge control valve (14):
a reservoir (2);
liquid supply means for connection to the liquid source (1);
gas supply means for connection to the carbon dioxide source (12);
a non-return valve (8);
a carbonating vessel (7) having a liquid inlet (9) to receive liquid from the reservoir (2) via the non-return valve (8), a gas inlet (15) to receive carbon dioxide from the gas supply means, and a dip tube (16) to withdraw carbonated liquid from the carbonating vessel;
a dispense outlet (17) for carbonated liquid to be associated with with the dispense valve (18);
a pressure relief valve (20) to vent gas from the carbonating vessel (7);
wherein said flow assembly defines a liquid flow path between the liquid source (1) and the dispense outlet (17) and wherein, during a maintenance operation, the flow assembly can be removed from the apparatus and replaced.

16. A method of operating apparatus for producing carbonated beverages which apparatus includes:
a reservoir (2);
a liquid source (1) to supply liquid;
a carbon dioxide source (12) to supply carbon dioxide;
a non-return valve (8);
a carbonating vessel (7) having a liquid inlet (9) to receive liquid from the reservoir (2) via the non-return valve (8), a gas inlet (15) to receive carbon dioxide from the carbon dioxide source (12), and a dip tube (16) to withdraw carbonated liquid from the carbonating vessel;
a dispense outlet (17) for carbonated liquid;
a dispense valve (18) to control the supply of carbonated liquid from the dip tube (16) to the dispense outlet (17);
a flow assembly (30) defining a liquid flow path between the liquid source (1) and the dispense outlet (17), said flow assembly including the reservoir (2) and the carbonating vessel (7);
a pressure relief valve (20) to vent gas from the carbonating vessel (7);
a charge control valve (14) to control the supply of carbon dioxide from the carbon dioxide source (12) to the carbonating vessel (7);
a controller (35) arranged to control the dispense valve (18) and the charge control valve (14);
wherein, during a maintenance operation, the flow assembly (30) can be removed from the apparatus and replaced;
wherein the controller (35) has the following modes of operation
charge: the dispense valve (18) is held closed while the charge control valve (14) is opened to admit a charge of carbon dioxide into the carbonating vessel (7);
dispense/refill: the dispense valve (18) is opened to dispense carbonated liquid while liquid flows into the carbonating vessel from the reservoir (2) via the non-return valve (8).

17. A method according to claim 16 wherein the charge control valve (14) is closed for at least part of the dispense/refill period.

18. A method according to claim 16 wherein, on receipt of a dispense command, the controller operates with the sequence: dispense/refill—charge.

19. A method according to claim 18 wherein, during the dispense/refill period, a quantity of non-carbonated liquid is dispensed to dilute the strength of the dispensed carbonated liquid.

20. A method according to claim 16 having a flavour enhancement dosing system which includes:
a disposable container (80) which holds a concentrated flavour enhancement;
an air pump (81);
wherein the air pump (81) is arranged to produce a flow of air which entrains droplets of the concentrated flavour enhancement and delivers them into the dispensed liquid.

21. Apparatus for producing carbonated beverages according to claim 1 wherein a quantity of non-carbonated liquid is dispensed to dilute the strength of the dispensed carbonated liquid.
